(19) United States
(12) Patent Application Publication
(10) Pub. No.: US 2004/0122840 A1
(43) Pub. Date: Jun. 24, 2004

(54) System for examining patent and trademark applications

(76) Inventors: Alfred Basichas, Arlington, VA (US); Bradley N. Ruben, Weehawken, NJ (US)

Correspondence Address: Bradley N. Ruben, PC, Suite 5A, 463 First Street, Hoboken, NJ, 07030, US

(21) Appl. No.: 10/395,522

(22) Filed: Mar. 24, 2003

Related U.S. Application Data
(60) Provisional application No. 60/366,932, filed on Mar. 22, 2002.

(51) Int. Cl. G06F 17/00

(52) U.S. Cl. 707/101

(57) ABSTRACT

The present invention relates to a system of examining patent applications. Particularly, a system in which a portion of the examining core is spread out at various locations away from the central location of the Patent and Trademark Office. Examiners located all over the country can conduct their examining duties from an office set up at home. Giving Examiners the option of living anywhere in the country provides a greater incentive for them to remain employees of the Patent Office. Additionally, this system increases interest in becoming a patent Examiner for hundreds of patent agents and attorneys whose main reason for leaving, or not joining, the Patent Office was, and is, being restricted to the limited commutable area in which they must live. In this way, the pool from which the Patent Office can hire, or contract work, increases by hundreds of highly motivated, and qualified candidates.

### PRIOR APPLICATIONS

This application is based on provisional application 60/366,932, filed 22 Mar. 2002, the disclosure of which is incorporated herein by reference.

### BACKGROUND

1. Field of the Invention

The present invention relates to a distributed computer system for examining patent and trademark applications. More particularly, the present invention relates to a system for examining patent and trademark applications in a distributed manner by which examination is conducted all over the country (or all over the planet) by qualified individuals without the need to be physically located in the a central examination office.

2. The State of the Art

Today's technology has allowed for great strides in the manner in which business is conducted. With the prolific use of computers in general, and the internet specifically, business is no longer limited to local endeavors. While international business is not a new concept, the advent and wide usage of computers together with the internet has allowed small businesses the opportunity reach markets they would normally not have the capital to exploit. Today, a single individual can operate an international business without fear for lack of networking contacts, a multinational sales force, translators, inventory, and the like. Today's technology has even made it possible for a unilingual individual to communicate with other such individuals in foreign countries so different that it seemed impossible, and was impractical, only ten years ago. There are systems available, at affordable rates, that permit a person in the United States to communicate with another in Kazakhstan. Translation is performed practically instantaneously, allowing two varied individuals, from two varied cultures, with extremely varied languages, to communicate as if they were speaking the same language.

The United States Patent and Trademark Office (USPTO) has taken great leaps in the examination of patent and trademark applications by taking advantage of today's technology. The USPTO has been able to provide an increasingly higher quality product by modernizing key aspects of patent examination. Searching prior inventions and other publications (prior art) has been made easier by automated patent search tools, and is even available to the public via the USPTO and other service providers. Simply by entering key words, it is possible to bring up relevant prior art. This electronically-available information has made it possible for individuals to conduct effective searches without the need to go personally to the USPTO. Prior art searching can be done by anyone, anywhere, as long as they have a computer and a connection to the internet.

In an effort to streamline and modernize patent and trademark examination, the USPTO has implemented many programs that have substantially improved the process, such as providing each Examiner with a computer, and providing for automated search tools. Additionally, in an effort to hold on to highly qualified individuals, the USPTO has implemented many education and back-office programs to improve the benefits and quality of the work environment, such as flexible work schedules for both full-time and part-time employees.

The ability of a corporation, whether it be private, public, or a government agency, to retain highly qualified and motivated individuals is essential to its effectiveness and success. The USPTO has consistently had, and continues to have, the problem of keeping Examiners on board. Many Examiners are lured away to become agents and attorneys in the private sector, and an even greater number of highly motivated and capable individuals will not even consider the USPTO because they are not willing to move to Washington D.C. For those individuals, the benefits of such a career is outweighed by their independent nature and desire to remain in their home town. Others, while taking the post initially, consider the position a temporary one, where they can develop essential skills and experience while they focus on their chosen career. For most of these individuals, their chosen career is often as attorneys back home. This is extremely detrimental to the personal knowledge base of the USPTO, as it precludes the USPTO from retaining highly qualified and motivated individuals.

The attrition rate for new hires is astonishingly high, leaving the USPTO perpetually short-handed. As a result, this high turn-around causes delays in examination for which the USPTO has become notorious. With relatively few highly experienced Examiners remaining for life long careers, patent and trademark applications cannot be processed as quickly because the productivity, and job-acquired knowledge, of new hires is substantially lower than that of experienced Examiners. To make matters worse, the productivity of the experienced Examiner is often reduced as a result of the time spent in training new hires. Another major problem facing the USPTO is that many important applications and inventions are examined by junior Examiners with little experience. While these Examiners are supervised by more experienced Examiners, too many errors seem to get through anyway, and it is frustrating for those prosecuting such applications to have to explain, in more detail than would be required for a more seasoned examiner, the technology and sometime Office procedure to these junior Examiners.

While the USPTO is be experimenting with a pilot program that provides Examiners with the opportunity to work from home, this program is mostly limited to an area closely proximate to the USPTO itself. This still limits the USPTO to a relatively small group willing to remain close to the D.C. area. The majority of highly trained, motivated, and productive individuals that do not wish to live near the USPTO are left outside of the loop.

### OBJECTS AND SUMMARY

Accordingly, it is an object of the present invention to provide a more effective method of examining patent and trademark applications.

It is further an object of the present invention to provide a system in which examination of patent applications may be conducted by full-time, part-time or contract Examiners in geographically diverse areas, particularly for the USPTO anywhere in the United States.

It is a further object of the present invention to provide a system in which continued and updated training may be conducted via a computer with access to the internet or the USPTO intranet.

It is yet a further object of the present invention to provide a system in which applicants and/or their representatives need not travel to the Patent Office headquarters for an in person interview with an Examiner, but can conduct such interviews more local to their or their client's location.

It is still a further object of the present invention to provide a system which overcomes the high attrition rate of Examiners and promotes a large, highly experienced, highly qualified and dependable examining core.

The present invention provides a system for examining patent and/or trademark applications. Particularly, a system in which a portion of the examining core is spread out at various locations remote from the central location of the USPTO. Examiners located all over the country can conduct their examining duties from an office set up at home. This system provides a greater incentive for Examiners to remain employees of the Patent Office, while being given the opportunity to live anywhere in the country. Additionally, this system increases interest for qualified individuals in becoming Examiners for hundreds of patent and trademark agents and attorneys whose main reason for leaving, or not joining, the USPTO was, and is, being restricted to the limited commutable area in which they must live. In this way, the pool of talented and highly qualified personnel from which the USPTO can hire, or contract work, increases by hundreds of highly motivated, and qualified candidates.

### BRIEF DESCRIPTION OF THE FIGURE

FIG. 1 depicts an overall arrangement of several embodiments of the present invention.

FIG. 2 depicts a specific arrangement of a preferred embodiment of the present invention.

FIG. 3 depicts a specific arrangement of an alternate preferred embodiment of the present invention.

### DETAILED DESCRIPTION

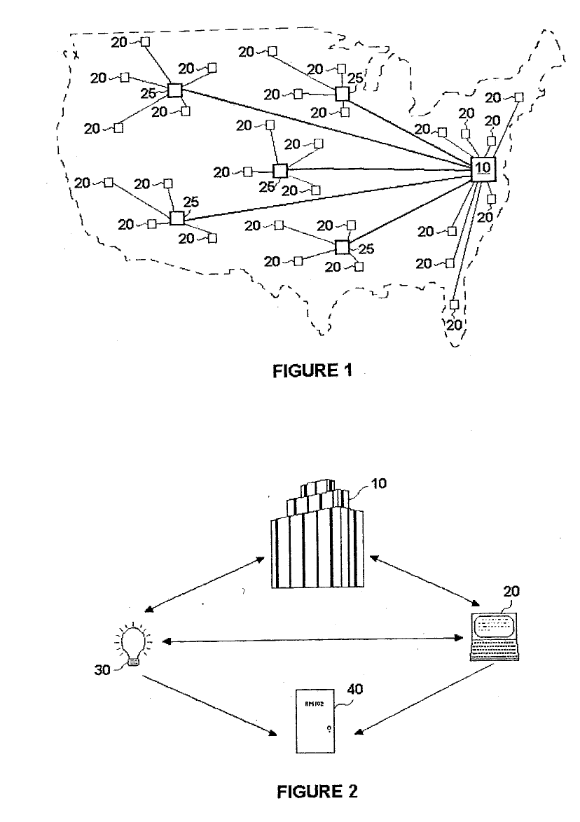

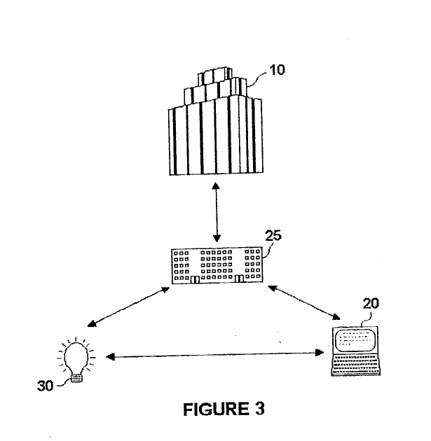

As shown in FIG. 1, the preferred overall arrangement of the present invention includes the Patent and Trademark Office 10 at a central location, and Examiners 20 at various locations all over the country. This arrangement depicts several embodiments in which the Examiners would be in direct contact with the Central Office, and/or strategically located satellite offices 25 may be utilized as intermediaries between the Examiners and the Central Office. These satellite offices may also be used as convenient locations for personal interviews between Examiners and applicants.

As shown in FIG. 2, a specific arrangement of a preferred embodiment of the present invention involves a relationship between the Patent and Trademark Office and each individual remotely located Examiner. The Central Office 10 of the present invention includes all or most of the same features that it contains today, such as an extensive computer and electronic storage system that includes prior art data, electronically and/or manually stored applications, including initial filings, amendments, official actions, and all other correspondence and relevant legal information regulations, case law, and agency rules (e.g., Manual of Patent Examining Procedure). These files are made available through the internet, a USPTO intranet, or other such communications system, including virtual private networks, for Examiners to utilize in the performance of their duties.

The Central Office also provides clerical support for docketing and classification of applications, as well as data entry and dissemination. Naturally, the Central Office can provide initial training of all Examiners, including continuing education, legal updates, and procedural updates. With the likely exception of at least part of the initial training, continuing education and updates (legal and/or procedural) preferably take the form of teleconferences and online education and simulation computer programs, which should include tests that are evaluated, manually and/or electronically, at the Central Office. If an Examiner's performance is determined to be poor, then he or she could be required to attend a more intensive program at the Central Office.

The remotely-located Examiner is provided with a computer system, which is capable of receiving data (e.g., graphical and/or textual information), to enable the Examiner to conduct adequate searches, review electronically and manually entered application papers, including amendments and official actions, as well as the rules, case law, and other procedural data. After the Examiner has reviewed the application, conducted a search of the relevant prior art, and consulted the pertinent rules and regulations, he transmits the appropriate correspondence to the Central Office and/or the Applicant.

The official actions, along with the prior art made of record during the examination, can be stored in files which are either saved on a hard disc and mailed to the Central Office, or simply sent directly via email or other such method using a secured line, in order to maintain confidentiality. These transmissions may be made to the applicant either directly from the Examiner, at the same time as they are sent to the Central Office, or from the Central Office after they have been received and docketed. Preferably, they are sent from the Central Office, where they can be communicated to the applicant by any means allowed by the applicable law or rules, and simultaneously stored (manually or electronically) and docketed as having been communicated to the applicant. (Of course, the practitioner will realize that “applicant” means an applicant or his representative.)

Continued legal and procedural updates are an extremely important aspect of assuring the quality of the USPTO's product. Accordingly, the Examiner's system is capable of receiving, initializing, and running training programs of continuing education, as well as legal and procedural updates. The system also includes a calendar/docketing program for receiving, storing, tracking, updating, computing, and disseminating information relating to deadlines and due dates for applications, amendments, and official actions, based on the rules, case law, and procedural data.

To assure the security of the communications between the Examiner and the Central Office (i.e., present U.S. law provides that patent applications are maintained as secret, and so communications among the Examiner, Central Office, and Applicant must be maintained in confidence), an encoding-based security system can be used. First, the Examiner is given a secure means, such as a password but preferably a physical security card unique for that Examiner, and the card is read by a card reader (magnetically and/or optically and/or mechanically) as part of an authorization protocol to enable the Examiner to “log on” to a satellite office or the Central Office computer to send or receive information. When an Examiner sends a communication, the correspondence should have a digital signature, at least part of which can be taken or derived from the code on the security card. Each document generated (whether by the Examiner, the Central Office, or the Applicant) for a particular application (or multiple applications/patents) can be assigned a coded identification so that it can be associated with the proper file. The use of a digital signature also allows for Supervisory Examiners to be electronically associated with the Examiners for which they are responsible, so that a Supervisory Examiner can be in one location while an Examiner is in another location, each separate from the Central Office location. The coding of correspondence and digital signatures also allows Central Office to facilitate communication with the Applicant, such as by combining an Applicant's unique identification (e.g., as in the USPTO's PAIR system) with a unique identification code associated with a given application. The use of a separate security device, rather than physical characteristics of the Examiner (e.g., a fingerprint, or facial recognition data), maintains the privacy of the examiner.

The electronic database(s) at the Central Office storing the application data can be used to direct related cases to the same examiner, and to send to Examiners in different technology units, and examining related cases, information regarding new prior art citations for each other's case. As different parts of an application may have to be in different branches of the Central Office, a physical copy of the application can remain in a single location and a virtual copy of the application (or necessary part thereof) can be sent to the requesting branch; and likewise a branch office can enter a paper into the file without having the physical file. Preferably, for all communications, a single hard copy is maintained in a single location devoted to maintaining a hard copy of each application file.

To some extent, other problems can be alleviated, or can be addressed. Presently, the office hours of any central patent office are set by the physical, geographical location in which the office is located, even if the country spans multiple time zones. With each satellite office accepting electronic and/or facsimile communications from Applicants, the receipt of such correspondence can be electronically tagged, so that the Patent Office can effectively stay open continuously. Accordingly, the rules could allow for the filing at a satellite office in a later time zone after a specified time at the Central Office location. As various national patent offices allow for an Applicant to conduct a personal interview with an Examiner, an Applicant could have an interview directly with an Examiner at a satellite office, they could meet at a given satellite office, the Applicant could travel to his local satellite office and conduct an interview with another Examiner (or Supervisor) who later confers with the initial examiner, or the Applicant could travel to his local satellite office while the Examiner travels to her local satellite office and they communicate by video teleconferencing, so allowing for demonstrations.

Providing the Examiner the option of living anywhere in the country provides the USPTO with an extensive pool of highly talented, qualified, and most importantly experienced personnel. These individuals would further provide the USPTO with the stable and experienced core of Examiners that would allow for the efficient and expedient flow of a high quality product.

While this system has been described with respect to use in a patent and/or trademark office, it can be adapted for use by any government agency desirous of having a distributed application and/or examination system.

While the foregoing has described and exemplified aspects of various embodiments of the present invention, those skilled in the art will recognize that alternative elements and techniques, and/or combinations and sub-combinations of the described elements and techniques, can be substituted for, or added to, the embodiments and methods described herein. The present invention, therefore, should not be limited to, or defined by, the specific apparatus, methods, and articles-of-manufacture described herein, but rather by the appended claims, which are intended to be construed in accordance with well-settled principles of claim construction, including, but not limited to, the following:

Limitations should not be read from the specification or drawings into the claims (e.g., if the claim calls for a “chair,” and the specification and drawings show a rocking chair, the claim term “chair” should not be limited to a rocking chair, but rather should be construed to cover any type of “chair”).

The words “comprising,” “including,” and “having” are always open-ended, irrespective of whether they appear as the primary transitional phrase of a claim, or as a transitional phrase within an element or sub-element of the claim (e.g., the claim “a widget comprising: A; B;

and C” would be infringed by a device containing 2A's, B, and 3C's;

also, the claim “a gizmo comprising: A; B, including X, Y, and Z; and C, having P and Q” would be infringed by a device containing 3A's, 2X's, 3Y's, Z, 6P's, and Q).

The indefinite articles “a” or “an” mean “one or more”; where, instead, a purely singular meaning is intended, a phrase such as “one,” “only one,” or “a single,” will appear.

Where the phrase “means for” precedes a function, it is intended that the resulting means-plus-function element be construed to cover any, and all, implementations of the recited function using any standard techniques known by, or available to, persons skilled in the relevant art. A claim that contains more than one means-plus-function element should not be construed to require that each means-plus-function element must be a structurally distinct entity; rather, such claim should be construed merely to require that the overall combination which implements the invention must, as a whole, implement at least the functions called for by the claims.

What is claimed is:

1. A system for examining patent and/or trademark applications comprising:
a. a central office having:
i. at least one computerized storage system adapted to contain application data, electronically and/or manually entered, of a graphical and/or textual nature, related to said applications;
ii. means for providing clerical support, docketing, classification, data entry, and data dissemination; and
iii. means for providing initial training, continuing education, legal updates, and procedural updates;
b. at least one remote computer system, at a location remote from said central office, having:
i. means for electronically receiving and optionally storing application data from said central office;
ii. means for electronically creating and transmitting, and optionally storing, application data from said central office;
iii. means for running electronic programs transmitted from said central office, and preferably selected from the group of said training, said continuing education, said legal updates, and said procedural updates; and
iv. means for receiving, storing, tracking, updating, computing, and disseminating information relating to deadlines and due dates for said application data, based on said rules.

2. The system for examining patent and/or trademark applications according to claim 1, wherein said means for receiving, storing, tracking, updating, computing, and disseminating information relating to deadlines and due dates contains axioms based on laws selected from the group consisting of rules, regulations, and/or statute, which axioms are changed to reflect changes in said group.

3. The system for examining patent and/or trademark applications according to claim 1, further comprising a security device, wherein the central office assigns to an examiner said security device encoded magnetically, optically, and/or mechanically with information particularly identifying an individual examiner, and further comprising a security means at said remote location allowing access to application data requiring via authorization protocol the information encoded on said security device.

4. The system for examining patent and/or trademark applications according to claim 3, further comprising applying a digital signature to information transmitted by an examiner from a remote computer wherein the digital signature is derived, at least in part, from information encoded onto said security device.

5. A system for examining patent and/or trademark applications comprising:
a. a central office having:
i. at least one computerized storage system adapted to contain application data, electronically and/or manually entered, of a graphical and/or textual nature, related to said applications;
ii. means for providing clerical support, docketing, classification, data entry, and data dissemination; and
iii. means for providing initial training, continuing education, legal updates, and procedural updates;
b. at least one remote computer system, at a location remote from said central office, having:
iv. means for electronically receiving and optionally storing application data from said central office;
v. means for electronically creating and transmitting, and optionally storing, application data from said central office;
vi. means for running electronic programs transmitted from said central office, and preferably selected from the group of said training, said continuing education, said legal updates, and said procedural updates; and
vii. means for receiving, storing, tracking, updating, computing, and disseminating information relating to deadlines and due dates for said application data, based on said rules, wherein said means for receiving, storing, tracking, updating, computing, and disseminating information relating to deadlines and due dates contains axioms based on laws selected from the group consisting of rules, regulations, and/or statute, which axioms are changed to reflect changes in said group.

6. The system for examining patent and/or trademark applications according to claim 5, further comprising a security device, wherein the central office assigns to an examiner said security device encoded magnetically, optically, and/or mechanically with information particularly identifying an individual examiner, and further comprising a security means at said remote location allowing access to application data requiring via authorization protocol the information encoded on said security device.

7. The system for examining patent and/or trademark applications according to claim 6, further comprising applying a digital signature to information transmitted by an examiner from a remote computer wherein the digital signature is derived, at least in part, from information encoded onto said security device.

8. A system for examining patent and/or trademark applications comprising:
a. a central office having:
i. at least one computerized storage system adapted to contain application data, electronically and/or manually entered, of a graphical and/or textual nature, related to said applications;
ii. means for providing clerical support, docketing, classification, data entry, and data dissemination; and
iii. means for providing initial training, continuing education, legal updates, and procedural updates;
b. at least one remote computer system, at a location remote from said central office, having:
i. means for electronically receiving and optionally storing application data from said central office;
ii. means for electronically creating and transmitting, and optionally storing, application data from said central office;
iii. means for running electronic programs transmitted from said central office, and preferably selected from the group of said training, said continuing education, said legal updates, and said procedural updates; and
iv. means for receiving, storing, tracking, updating, computing, and disseminating information relating to deadlines and due dates for said application data, based on said rules; and
c. a security device, wherein the central office assigns to an examiner said security device encoded magnetically, optically, and/or mechanically with information particularly identifying an individual examiner, and further comprising a security means at said remote location allowing access to application data requiring via authorization protocol the information encoded on said security device.

9. The system for examining patent and/or trademark applications according to claim 8, further comprising applying a digital signature to information transmitted by an examiner from a remote computer wherein the digital signature is derived, at least in part, from information encoded onto said security device.

10. The system for examining patent and/or trademark applications according to claim 8, wherein said means for receiving, storing, tracking, updating, computing, and disseminating information relating to deadlines and due dates contains axioms based on laws selected from the group consisting of rules, regulations, and/or statute, which axioms are changed to reflect changes in said group.
